(19) United States
(12) Patent Application Publication
(10) Pub. No.: US 2018/0238281 A1
(43) Pub. Date: Aug. 23, 2018

(54) ACTUATOR ASSEMBLY OF A DIGITAL INLET VALVE

(71) Applicant: Delphi International Operations Luxembourg, S.A.R.L., Bascharage (LU)

(72) Inventors: Etienne Pereira, Cande-sur-Beuvron (FR); Raphael Rouillon, Onzain (FR); Walter Fresneau, Vineuil (FR); Jean-Luc Rouet, Chitenay (FR); Alexis Menand, Blois (FR)

(21) Appl. No.: 15/550,846

(22) PCT Filed: Feb. 2, 2016
(86) PCT No.: PCT/EP2016/052119

§ 371 Date: Aug. 14, 2017

(30) Foreign Application Priority Data
Feb. 18, 2015 (GB) 1502693.3

(51) Int. Cl. F02M 59/36; F02M 61/16

(52) U.S. Cl. CPC F02M 59/368; F02M 61/161; F02M 2200/07; F02M 63/0022; F02M 2200/8053; F02M 2200/8092; F02M 2200/08

(57) ABSTRACT

An actuator assembly of a digital inlet valve for a fuel pump adapted to cooperate with an inlet valve member includes an actuator body in which is fixed a coil, a cover closing the body and, a magnetic core arranged in a core guiding bore provided in the actuator body. The magnetic core is slidable along a main axis in order, in use, to close an air gap under the influences of a first compression spring, and of a magnetic field, the core cooperating with the valve member.

### CROSS REFERENCE TO RELATED APPLICATIONS

This application is a national stage application under 35 USC 371 of PCT Application No. PCT/EP2016/052119 having an international filing date of Feb. 2, 2016, which is designated in the United States and which claimed the benefit of GB Patent Application No. 1502693.3 filed on Feb. 18, 2015, the entire disclosures of each are hereby incorporated by reference in their entirety.

### TECHNICAL FIELD

The present invention relates generally to an actuator adapted to control an inlet valve of a fuel pump, the constituents of said actuator forming an autonomous assembly.

### BACKGROUND OF THE INVENTION

In well-known fuel injection equipment's, fuel is sucked from a reservoir and is sent at a few bars pressure toward a high pressure pump pressurizing the fuel to several thousands of bars. The inlet of the high pressure pump is controlled by an inlet valve controlled by an actuator.

In reference to FIGS. 1 and 2 is represented a typical digital inlet valve 10 of the prior art arranged over a fuel pump 12. The pump 12 comprises a head 14 partially shown, provided with an internal bore 16 axially extending along a main axis X.

In said bore 16 is arranged a piston member 18 which, in use, is reciprocally actuated, for instance by the rotation of a cam which outer face is followed by a cam follower combined with said piston member 18.

The upper part of said bore 16 constitutes with the top head of the piston 18 a compression chamber 20. The very top part of the pump head 14 comprises a passive inlet valve 22 normally closed. The valve 22 comprises a moveable valve member 24 cooperating with a fixed valve seat 26 in order to control an inlet opening 28 wherefrom fuel at a few bars pressure enters the compression chamber 20. Also, from the compression chamber 20 departs an outlet 30 controlled by an outlet valve, not represented.

As can be seen, the valve member 24 is a poppet valve having a stem 32 slidably adjusted and guided in a through bore 34 opening on the outer top face of the pump head 14. The stem 32 protrudes outwardly from the through bore 34 and, a valve spring 36 surrounding the stem 32 is compressed between an abutment face 38 provided on said outer top face of the pump head 14 and, a spring seat 40 fixed to the extremity of the stem 32. The valve spring 36 has a stiffness Kv and it generates an upward force that permanently solicits the valve member 24 toward a closing position CPV. Over the valve 22 is arranged an electromagnetic actuator assembly 42.

The actuator 42 comprises a cylindrical actuator body 44 covered by an actuator cover 46. The body 44 has a peripheral wall 48 axially X extending, the lower portion of the wall 48 aiming at being complementary arranged and fixed on the pump head 14, the lower face 50 of the wall 48 being in contact with an abutting face 52 of the pump head 14. The upper portion of the wall 48 axially X extends upwardly toward a distal top face 54 onto which is arranged and fixed the cover 46 so defining an internal volume V. Inside volume V, the body 44 comprises a transverse floor 56 radially extending from the inner face of the lower portion of the peripheral wall 48 toward a central opening forming a core guiding bore 58. The axial height H of said guiding bore 58 is limited to the thickness of the floor 56 or, as represented, it may be slightly augmented with a small vertical foot 60.

The cover 46 comprises a main disc member 64 which periphery fixedly lies on the top face 54 of the body 44 and also, a cylindrical member 66 integral to the disc member 64 and downwardly protruding inside the volume V toward a lower face 68. The outer face of said cylindrical member 66 aligns with the vertical foot 60 so that it defines within the internal volume V, an outer annular compartment 70 within which is fixedly arranged an electrical coil 72 which may be controlled by an external control unit, not represented. The cylindrical member 66 is further provided with a central blind bore 74 in which is arranged an actuator spring 76 compressed between the bottom of the blind bore 74 and, the upper face 78 of a magnetic core 80. The actuator spring 76 has a stiffness Ka superior to the stiffness Kv of the valve spring.

The magnetic core 80 has a cup-like shape which, in reference to the arbitrary orientation of the figure, is arranged upside-down covering the spring seat 40. The core 80 has a cylindrical wall 82 and a transverse bottom 84 with a central opening through which, in use, protrudes the stem 32. It is to be noted that the bottom 82 of the cup-like is indeed, considering the orientation of the figure, represented on the top of the core. The outer cylindrical face of the core cylindrical wall 82 is slidably adjusted in the guiding bore 58 and then, the core 80 is able to axially X translate between a bottom position where the inner face of the transverse bottom 84 abuts against the upper face to the spring seat 40 and, a top position where the outer face of the transverse bottom 84 abuts against the lower face 68 of the cylindrical member 66 of the cover 46. Although alternative embodiments are known, the presently described actuator is further provided with a first shim 88 adjusted between the core 80 and the spring seat 40, and also with a second shim 90 adjusted between the upper face of the core 78 and the lower face 68 of the cylindrical member.

The first shim 88 is provided to compensate for stack-up of manufacturing tolerances and, the second shim 90 is a amagnetic shim provided to avoid sticking of the magnetic armature when abutting against the cover.

The operation of the digital inlet valve 10 is now briefly explained.

In a first step, the coil 72 is not electrically energized and therefore, it does not generate a magnetic field. The core 80 sets in its bottom position has it is pushed by the actuator spring 76. In turn, the core 80 downwardly push the spring seat 40 forcing to maintain the valve 22 in an open state OS where the valve member 24 is at a distance from the valve seat 26. In this open state OS, the fuel is able to enter the compression chamber 20.

In a second step, the coil 72 is energized and it generates a magnetic field that attracts the magnetic core 80. The force generated by the coil 72 exceeds the force of the actuator spring 76 and, the core 80 upwardly translates closing the air gap G42 until it reaches its top position. In this top position, the core 80 does not contacts the spring seat 40 and therefore does not generate any force on the valve member 24 which is only subject to the upward force of the valve spring 36 and also to the force of the fuel that is being compressed in the compression chamber 20 upwardly pushing the valve member 24 toward a closed state CS of the valve 22. In the closed state CS the valve member 24 is in contact with the valve seat 26 sealing the inlet 28 and enabling further compression of the fuel in the compression chamber.

In the embodiment of FIG. 1, the valve 22 closes as soon as the coil is energized upwardly removing the core from the spring seat 40. The action of the actuator assembly 42 is then to maintain the valve open while the piston 18 initiates an upward translation compressing the fuel generating a closing force on the valve member 24. Maintaining the valve 22 in an open position enables to control the fuel quantity to be compressed by having some fuel exiting the chamber 20 at beginning of the piston upward displacement. By removing the force of the actuator spring, the valve member 24 is solely subject to the closing forces of the valve spring and of the compressed fuel in the chamber. In this embodiment the valve 22 is therefore a passive valve that is not directly controlled by the actuator.

The process to arrange the actuator assembly 42 over the pump head 14 comprises a preparation step, in which the body, the coil and the cover are pre-arranged together in a sub-assembly, an intermediate step, in which, the core and actuator spring are arranged over the valve member and, a final step, in which, the sub-assembly is arranged and fixed on the pump head 14.

The preparation step may be accomplished in a “preparation” location, such as a manufacturer's site while the intermediate step has to take place on site where the pump is, which can be different from the “preparation” location. Consequently the actuator assembly 72 internal dimensioning of key characteristics takes into account dimensions from the components of the actuator and from the pump itself.

The air gap G42 which is a key characteristic for the performance of the actuator is difficult to control has it is calculated as a function of dimensions intrinsic to the components of the actuator but also of the pump.

It is calculated by the following equation:

G42=A44−(B46+C40+D14+E84+T1+T2) where
G42 is the air gap
A44, intrinsic to the body, is the axial distance from the lower face 50 to the top face 54;
B46, intrinsic to the cover, is the axial distance from the under face of the disc portion to the lower face 68 of the cylindrical member;
C40, intrinsic to the valve, is axial thickness of the spring seat 40;
D14, intrinsic to the pump, is the axial distance from the face where abuts the spring seat to the face 38 where abuts the actuator housing;
E84, intrinsic to the core, is the thickness of the transverse bottom, and;
T1 and T2 are the respective thicknesses of the first and second shims.

### SUMMARY OF THE INVENTION

The present application proposes to solve the above mentioned problems by providing an actuator assembly of the digital inlet valve for a fuel pump, the actuator assembly being adapted to cooperate with an inlet valve member switching between an open state and a closed state. The actuator assembly comprises an actuator body 144 in which is fixed an electric coil being adapted to generate a magnetic field when electrically energized, an actuator cover 146 fixedly closing the actuator body and, a magnetic core arranged in a core guiding bore provided in the actuator body. The magnetic core is slidable along a main axis under the influence of said magnetic field against the force of a first compression spring in order, in use, to close an air gap G142, the core cooperating with the valve member.

The air gap G142 is calculated by the formula

G142=A144−(B146+T196) where,
A144 is an axial dimension intrinsic to the body and,
B 146 is an axial dimension intrinsic to the cover and,
T196 is an axial dimension intrinsic to the magnetic core.

The intrinsic dimension to the actuator body A144 is measured between a lower face of the body and a top face whereon lies a peripheral under face of the actuator cover and, the intrinsic dimension to the cover B146 is measured between the peripheral under face and a central under face and, the intrinsic dimension to the core is the thickness T196 of a flange of the core.

Furthermore, an under face of the flange abuts against a disc face of the actuator body when in open state and, an upper face of the flange, opposed to the bottom face, abuts against an under face of the cover when in closed state.

Also, the flange is maintained between said disc face and said under face of the cover and the first spring is compressed between the actuator cover and the magnetic core so that, the actuator body is closed by the actuator cover. The coil, the magnetic core and the first compression spring are held together forming an autonomous actuator assembly adapted to be fixedly arranged on the fuel pump.

Also, the actuator body comprises an outer peripheral cylindrical wall and an inner cylindrical wall, both walls extending along the main axis, the coil being arranged between said two walls, the internal face of the inner wall defining the core guiding bore.

Also, the core integrally comprises a main cylindrical member and the flange, the flange radially outwardly extending from the main member, the main cylindrical member being adjusted to be guided in the core guiding bore and to slide along the main axis.

Also, the flange is further provided with apertures enabling, in use, fuel to flow through said apertures.

Also, the magnetic core further comprises an upper central blind bore axially extending through the flange and inside the main member, said blind bore enabling guidance of the first compression spring.

The actuator assembly further comprises a first shim, being an adjusting shim arranged in order to compensate for manufacturing tolerances, the thickness of the first shim reducing the air gap G142.

The actuator assembly may further comprise a second shim being an amagnetic shim, arranged in order avoid sticking of the armature, the thickness of the second shim reducing the air gap G142.

The actuator assembly further comprises an electrical connector outwardly protruding from the actuator body and enabling, in use, complementary electrical connection with the coil.

The invention extends to a fuel pump having a pump head wherein is arranged a compression chamber within which, in use, fuel is able to enter via an inlet opening controlled by an inlet valve and exit via an outlet opening controlled by an outlet valve. The inlet valve has a valve member cooperating with an actuator assembly as described in any of the preceding paragraphs.

Also, the valve member has a stem having an end portion outwardly protruding outside the pump head, the stem axially sliding in a bore of the pump head for the valve member to switch between the open state and the closed state.

Also, the fuel pump comprises a second spring, also called valve spring, arranged over the protruding end portion of the stem, the second spring being compressed between a face of the pump head and spring-seat fixed to the extremity of the stem.

Also, the inlet valve is a passive valve which in absence of magnetic field generated by the coil, the magnetic core being pushed by the first spring abuts on the valve stem soliciting the valve member toward the open state and, when the coil is energized, the magnetic core being pulled away from the valve stem, the second spring soliciting the valve member toward the closed state.

### BRIEF DESCRIPTION OF THE DRAWINGS

The present invention is now described by way of example with reference to the accompanying drawings in which:

FIG. 1 is a typical digital inlet valve of the prior art.

FIG. 2 is the valve of FIG. 1 with the functional dimensions.

FIG. 3 is a first embodiment of an actuator of a digital inlet valve as per the invention.

FIG. 4 is a second embodiment of an actuator as per the invention with the functional dimensions.

FIG. 5 is an isometric view of a first embodiment of a magnetic core of the actuator of FIG. 3 or 4.

FIG. 6 is a second embodiment of a magnetic core of the actuator of FIG. 3 or 4.

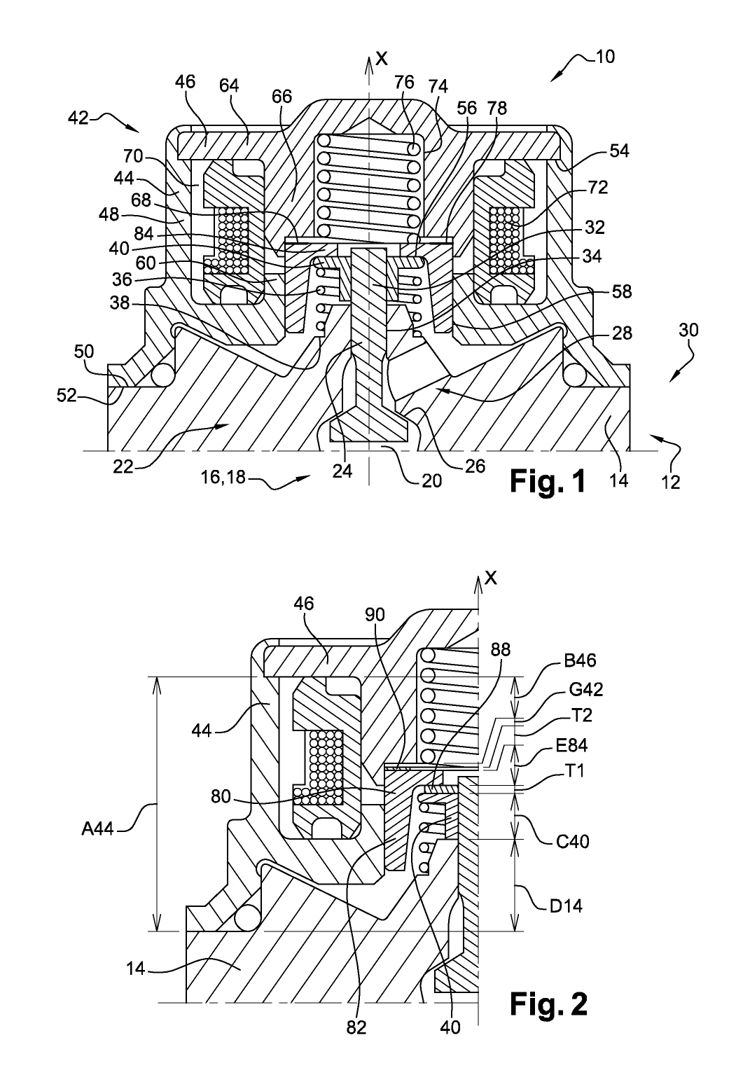

### DESCRIPTION OF THE PREFERRED EMBODIMENTS

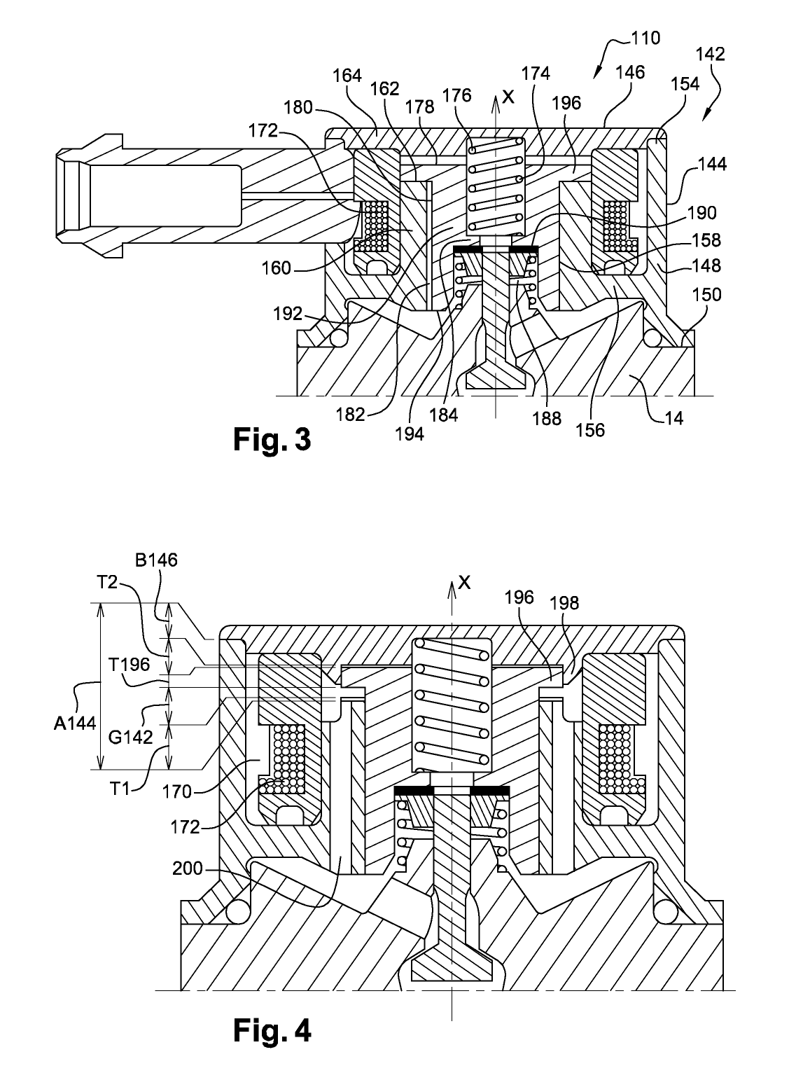

In reference to FIGS. 3 and 4 is now described an embodiment of an actuator 42 as per the invention. To support the description the numeral references differ from those of the prior art simply by adding “100” when designating similar features. As an example, the digital inlet valve is referenced 110, the actuator assembly is 142.

The actuator body 144 comprises, in place to the small vertical foot 60, a lengthy cylindrical member 160 upwardly extending from the transverse floor 156 of the body to a distal upper disc face 162.

The actuator cover 146 comprises a disc member 164 which periphery fixedly lies on the top face 154 of the body 144. The inner face of the cover is centrally provided with a small shallow recess 174 enabling to position the top turns of the actuator spring 176.

The magnetic core 180 comprises a main cylindrical member 192 axially extending from a lower face 194 to an upper face 178. In the upper part, the core comprises a flange 196 radially protruding from the main cylindrical member 192, said flange 196 having a thickness T196. The flange 196 and the main cylindrical member 192 are, in the present example, shown integral to each other although in alternative embodiments, the flange 196 may be a separate component fixed on the top of the cylindrical member 178.

The core 180 is further provided with an upper central recess 198 for arranging the actuator spring 176 and, similarly to the prior art, the core is also provided on its bottom part with an upside-down cup-like shape arranged over the stem 32 of the valve member 24 and over the spring seat 40. The transverse bottom of the cup-like is indeed a transverse wall 184 on the top if which abuts the actuator spring 176.

As visible on FIG. 3, the core 180 is adjusted in the core guiding bore 158 and the flange 196 radially extends between the upper disc face 162 of the cylindrical member of the actuator body and the under face of the cover. Since the core is axially guided the flange is captured between said two faces and the core cannot disassemble from the actuator assembly 142.

Similarly to the prior art actuator 42, the actuator assembly 142 may comprise a first shim 188, for tolerance stack-up adjustment, and a second amagnetic shim 190 arranged on each side of the flange 196.

The actual operation of the actuator assembly 142 is indeed similar to the operation of the prior art.

The method to arrange the actuator assembly 142 over the pump head 14 solely comprises a preparation step where the body 144, the core 180, coil 172 the actuator spring 176 and the cover 146 are pre-assembled together in a complete sub-assembly, before the final step where said actuator assembly 142 is arranged and fixed in place over the pump head 14.

In reference to FIGS. 3 and 4, the dimensioning of the air gap G142 of this actuator assembly 142 is simplified as it only depends upon dimensions intrinsic to the components of the actuator and, dimensions of the pump head 14 are not needed.

The air-gap G142 is calculated by the following equation:

G142=A144−(B146+T196+T1+T2) where
G142 is the air gap
A144, intrinsic to the body, is the axial distance from the upper disc face of the cylindrical inner member 162 to the top face;
B146, intrinsic to the cover, is the axial distance from the under face of the disc portion to the under face of the cover where abuts the core;
T196, intrinsic to the core, is the axial thickness of the flange 196;
T1 and T2 are the respective thicknesses of the first 188 and second 190 shims.

The actuator assembly 142 represented on FIG. 3, and the actuator assembly represented on FIG. 4, differ by at least two characteristics. At first, the cover 146 of FIG. 3 comprises a small inner circular protrusion 198 defining a large recess in which the flange 196 axially travels. This small protrusion 198 has substantially a height equivalent to the thickness T196 of the flange 196. To the contrary, the cover 146 of FIG. 3 is not provided with such small protrusion but the flange 196 radially extends over the complete thickness of the cylindrical inner member 160, up to the coil 172. The cover 146 of FIG. 3 comprises three concentric plane disc-faces and a central minor recess for locating the actuator spring.

In operation, the digital inlet valve is filled with fuel and, the coil is protected by O-ring. The fuel is able to flow upward through long holes 200 provided in the wall thickness of the cylindrical inner member 160 of the actuator body 144. Alternatively to long holes, fuel passages can be arranged by creating flats on the main cylindrical member of the core 192.

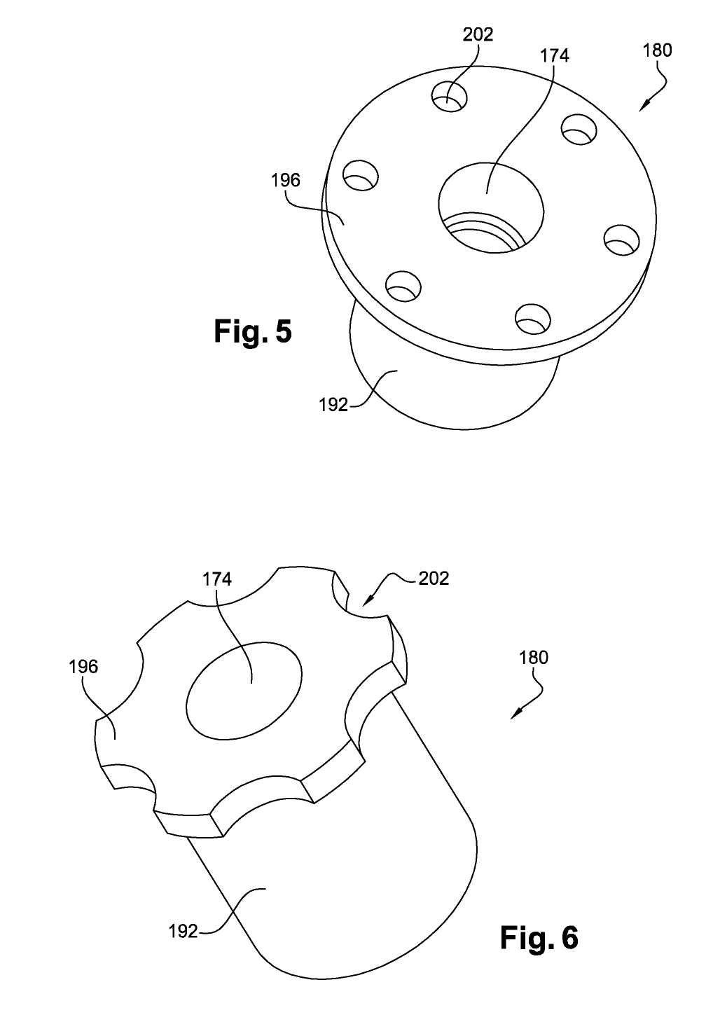

Furthermore, in reference to FIGS. 5 and 6 two alternatives of a core 180 are described, each having apertures 202 provided in the flange 196. In the first alternative, FIG. 5, the flange 196 is provided with six through holes. Any other number is of course possible. In the second alternative of FIG. 6, the flange is provided at its periphery with six inwardly curved apertures so that when the edge of the flange slides against the small wall 198 or against a cylindrical face of the coil, said curved apertures forms easy passage for the fuel.

LIST OF REFERENCES

| prior art | invention | |
|---|---|---|
| 10 | 110 | digital inlet valve |
| 12 | | fuel pump |
| 14 | | pump head |
| 16 | | bore |
| 18 | | piston |
| 20 | | compression chamber |
| 22 | | valve |
| 24 | | valve member |
| 26 | | valve seat |
| 28 | | opening |
| 30 | | outlet |
| 32 | | stem |
| 34 | | valve guiding bore |
| 36 | | valve spring |
| 38 | | abutment face of the pump head |
| 40 | | spring seat |
| 42 | 142 | actuator assembly |
| 44 | 144 | actuator body |
| 46 | 146 | actuator cover |
| 48 | 148 | peripheral wall |
| 50 | 150 | lower face of the wall |
| 52 | | abutting face of the pump head |
| 54 | 154 | top face of the peripheral wall |
| 56 | 156 | transverse floor |
| 58 | 158 | core guiding bore |
| 60 | 160 | 60: vertical foot-160: cylindrical inner |
| | | member |
| 162 | | upper disc face of the cylindrical inner |
| | | member |
| 64 | 164 | disc member of the cover |
| 66 | | cylindrical member of the cover |
| 68 | | lower face of the cylindrical member |
| 70 | 170 | outer annular compartment |
| 72 | 172 | coil |
| 74 | 174 | central blind bore |
| 76 | 176 | actuator spring |
| 78 | 178 | upper face of the core |
| 80 | 180 | magnetic core |
| 82 | 182 | cylindrical wall of the core |
| 84 | 184 | 84: transverse bottom-184: transverse wall |
| | | of the core |
| 88 | 188 | first shim |
| 90 | 190 | second shim |
| 192 | | main cylindrical member of the core |
| 194 | | lower face of the core |
| 196 | | flange |
| 198 | | small protrusion |
| 200 | | long holes |
| 202 | | apertures |
| X | | main axis |
| V | | internal volume |
| H | | height of the core guiding bore |
| Kv | | stiffness of the valve spring |
| Ka | | stiffness of the actuator spring |
| OS | | open state of the valve |
| CS | | closed state of the valve |
| G42 | | air gap of the prior art actuator |
| G142 | | air gap of the actuator as per the invention |
| A44 | A144 | distance from the lower face to the top face |
| | | of the body |
| B46 | B146 | distance from the under face of the disc |
| | | portion to the lower face of the cylindrical |
| | | member |
| C40 | | thickness of the spring seat |
| D14 | | distance from the face of the pump head |
| | | where abuts the spring seat to the face where |
| | | abuts the actuator housing |
| E84 | | thickness of the transverse bottom of the |
| | | core |
| T1 | T1 | thicknesses of the first shim |
| T2 | T2 | thicknesses of the second shim |
| | T196 | thickness of the flange |

1-15. (canceled)

16. An actuator assembly of a digital inlet valve for a fuel pump, the actuator assembly being adapted to cooperate with an inlet valve member switching between an open state and a closed state, the actuator assembly comprising:
an actuator body in which is fixed an electric coil adapted to generate a magnetic field when electrically energized;
an actuator cover fixedly closing the actuator body; and
a magnetic core arranged in a core guiding bore provided in the actuator body, the magnetic core being slidable along a main axis under the influence of said magnetic field against the force of a first compression spring in order, in use, to close an air gap, the magnetic core cooperating with the inlet valve member, characterized in that
the air gap is calculated by the formula
G142=A144−(B146+T196) where,
A144 is an axial dimension intrinsic to the actuator body and,
B146 is an axial dimension intrinsic to the actuator cover and,
T196 is an axial dimension intrinsic to the magnetic core.

17. An actuator assembly as claimed in claim 16 wherein, the axial dimension intrinsic to the actuator body is measured between a lower face of the actuator body and a top face whereon lies a peripheral under face of the actuator cover and,
the axial dimension intrinsic to the actuator cover is measured between the peripheral under face and a central under face and,
the axial dimension intrinsic to the magnetic core is a thickness of a flange of the magnetic core.

18. An actuator assembly as claimed in claim 17 wherein
an under face of the flange abuts against a disc face of the actuator body when in the open state and
an upper face of the flange, opposed to the under face of the flange, abuts against an under face of the actuator cover when in the closed state.

19. An actuator assembly as claimed in claim 18 wherein the flange is maintained between said disc face and said under face of the actuator cover and wherein the first compression spring is compressed between the actuator cover and the magnetic core so that, the actuator body is closed by the actuator cover, the electric coil, the magnetic core and the first compression spring are held together forming an autonomous actuator assembly adapted to be fixedly arranged on the fuel pump.

20. An actuator assembly as claimed in claim 17 wherein the actuator body comprises an outer peripheral cylindrical wall and an inner cylindrical wall, both the outer peripheral cylindrical wall and the inner cylindrical wall extending along the main axis and the electric coil being arranged between the outer peripheral cylindrical wall and the inner cylindrical wall, an internal face of the inner cylindrical wall defining the core guiding bore.

21. An actuator assembly as claimed in claim 20 wherein the magnetic core integrally comprises a main cylindrical member and the flange, the flange radially outwardly extending from the main cylindrical member, the main cylindrical member being adjusted to be guided in the core guiding bore and to slide along the main axis.

22. An actuator assembly as claimed in claim 21 wherein the magnetic core further comprises an upper central blind bore axially extending through the flange and inside the main cylindrical member, said upper central blind bore enabling guidance of the first compression spring.

23. An actuator assembly as claimed in claim 17 wherein the flange is further provided with apertures enabling, in use, fuel to flow through said apertures.

24. An actuator assembly as claimed in claim 16 further comprising a first shim being an adjusting shim arranged in order to compensate for manufacturing tolerances, a thickness of the first shim reducing the air gap.

25. An actuator assembly as claimed in claim 24 further comprising a second shim being an amagnetic shim arranged in order avoid sticking of the magnetic core, the thickness of the second shim reducing the air gap.

26. An actuator assembly as claimed in claim 16 further comprising an electrical connector outwardly protruding from the actuator body and enabling, in use, complementary electrical connection with the electric coil.

27. A fuel pump comprising:
a pump head wherein is arranged a compression chamber within which, in use, fuel is able to enter via an inlet opening and exit via an outlet opening;
an inlet valve which controls fuel entering the compression chamber via the inlet opening; and
an outlet valve which controls fuel exiting the compression chamber via the outlet opening;
wherein the inlet valve inlet valve has a valve member which is switched between an open state and a closed state by an actuator assembly the actuator assembly comprising:
an actuator body in which is fixed an electric coil adapted to generate a magnetic field when electrically energized;
an actuator cover fixedly closing the actuator body; and
a magnetic core arranged in a core guiding bore provided in the actuator body, the magnetic core being slidable along a main axis under the influence of said magnetic field against the force of a first compression spring in order, in use, to close an air gap, the magnetic core cooperating with the inlet valve member, characterized in that
the air gap is calculated by the formula
G142=A144−(B146+T196) where,
A144 is an axial dimension intrinsic to the actuator body and,
B146 is an axial dimension intrinsic to the actuator cover and,
T196 is an axial dimension intrinsic to the magnetic core.

28. A fuel pump as claimed in claim 27 wherein the valve member has a stem having an end portion outwardly protruding outside the pump head, the stem axially sliding in a bore of the pump head for the valve member to switch between the open state and the closed state.

29. A fuel pump as claimed in claim 28 further comprising a second spring arranged over the end portion of the stem, the second spring being compressed between a face of the pump head and a spring-seat fixed to an extremity of the stem.

30. A fuel pump as claimed in claim 29 wherein the inlet valve is a passive valve which, in absence of magnetic field generated by the electric coil, the magnetic core being pushed by the first spring abuts on the valve stem soliciting the valve member toward the open state and wherein, when the electric coil is energized, the magnetic core being pulled away from the valve stem, the second spring soliciting the valve member toward the closed state.
